(19) United States
(12) Patent Application Publication
(10) Pub. No.: US 2013/0224763 A1
(43) Pub. Date: Aug. 29, 2013

(54) BIOLOGICAL MOLECULE DETECTING APPARATUS AND BIOLOGICAL MOLECULE DETECTING METHOD

(71) Applicant: FUJIFILM CORPORATION, (US)

(72) Inventor: Toshihito KIMURA, Ashigarakami-gun (JP)

(73) Assignee: FUJIFILM CORPORATION, Tokyo (JP)

(21) Appl. No.: 13/854,494

(22) Filed: Apr. 1, 2013

Related U.S. Application Data
(63) Continuation of application No. PCT/JP2011/005498, filed on Sep. 29, 2011.

(30) Foreign Application Priority Data
Sep. 30, 2010 (JP) 2010-223043
Jun. 1, 2011 (JP) 2011-123100

(51) Int. Cl. G01N 21/64

(52) U.S. Cl. CPC G01N 21/6486
USPC 435/7.4; 436/501; 435/287.2; 422/69

(57) ABSTRACT

A biological molecule detecting apparatus capable of highly sensitive measurements is provided. A laser was emitted onto a solution, to impart external force onto free molecules and binding molecules within the solution. The external force inhibited Brownian motion of the free molecules and the binding molecules. The concentration of a detection target substance which is associated the binding molecules can be measured with high sensitivity, by measuring the Brownian motion of the free molecules and the binding molecules within the solution irradiated with the laser.

### TECHNICAL FIELD

The present invention is related to technology for detecting detection target substances within solutions. Particularly, the present invention is related to a biological molecule detecting apparatus and a biological molecule detecting method capable of detecting biological molecules, viruses, nucleic acids, proteins, and germs within samples.

### BACKGROUND ART

Recently, biological molecule detecting methods, in which physicians or technicians detect biological molecules at points of care, immediately obtain measurement results, and utilize the measurement results for diagnosis and treatment, are being focused on. Biological molecule detecting methods are methods for selectively detecting only detection target substances from within bodily fluids such as blood, urine, and sweat, which have multiple components, by the high selectivity of specific reactions such as antigen antibody reactions. Such biological molecule detecting methods are particularly widely employed to detect, inspect, quantify, and analyze small amounts of biological molecules, such as viruses, nucleic acids, proteins, and germs.

Radioimmunoassay is a biological molecule detecting method which is in practical use. Radioimmunoassay employs antigens or antibodies labeled with isotopes, and detects the presence of antibodies or antigens that specifically bind with the labeled antigens or the labeled antibodies. Radioimunoassay quantifies a detection target substance such as antibodies and antigens by measuring the radiation dosage of the isotopes, and is capable of highly sensitive measurement.

Fluorescence immunoassay is a biological molecule detecting method that does not employ radioactive substances. Fluorescence immunoassay apparatuses, in which antibodies are immobilized onto a reaction layer in advance (referred to as a solid phase), a measurement target solution and antibodies labeled with fluorescent molecules are caused to flow onto the reaction layer, and fluorescence in the vicinity of the reaction layer is observed to measure the concentration of antigens which have specifically bound to the antibodies, are known (refer to Japanese Unexamined Patent Publication No. 7 (1995)-120397, for example).

However, fluorescence immunoassay that utilizes solid phases has a problem that it is costly to produce the solid phases. There is a method that utilizes fluorescence polarization method to confirm antigen antibody reactions in solutions as a method that does not employ solid phases (that is, only a liquid phase is employed). The fluorescence polarization method is a method that detects changes in degrees of fluorescence polarization caused by changes in Brownian motion that occurs by the sizes of molecules changing by molecules binding with molecules which have fluorescent labels. The biological molecule detecting method that utilizes the fluorescence polarization method is known as a simple and expedient method for detecting detection target substances within samples (refer to Japanese Unexamined Patent Publication No. 2008-298743, for example).

### DISCLOSURE OF THE INVENTION

However, in a conventional fluorescence polarization method, it is necessary to detect the changes in the speed of Brownian motion, which is random. However, in order for the speed of Brownian motion to change significantly, a certain degree of change in the volumes of particles prior to and following the fluorescent labeled molecules binding to a detection target substance.

Japanese Unexamined Patent Publication No. 2008-298743 discloses that third molecules are employed such that the volumes of particles change significantly. However, in this case, it becomes necessary to prepare the third molecules.

The present invention has been developed in view of the foregoing circumstances. It is an object of the present invention to provide a biological molecule detecting apparatus having a simple structure and a biological molecule detecting method, which are capable of highly sensitive measurements.

A biological molecule detecting apparatus of the present invention that achieves the above object is that which detects fluorescence emitted by a first complex and a second complex within a solution, the first complex being formed by a substance that specifically binds with a detection target substance bound to a fluorescent molecule, and the second complex being formed by the first complex bound to the detection target substance, to detect or quantify the detection target substance, comprising:

a light source that emits excitation light toward the fluorescent molecules;

a light receiving section that detects the fluorescence emitted by the fluorescent molecules;

external force imparting means for imparting external force onto the first complex and the second complex; and

a calculating means that detects or quantifies the detection target substance based on the speed of Brownian motion of the first complex and the speed of Brownian motion of the second complex, which are changed by the external force being imparted thereto.

In the biological molecule detecting apparatus of the present invention, it is preferable for: the light source to emit linearly polarized excitation light that excites the fluorescent molecules; the light receiving section to have separating means for separating the fluorescence emitted by the fluorescent molecules into a first component having a vibration direction parallel to the vibration direction of the excitation light, and a second component having a vibration direction perpendicular to the vibration direction of the excitation light; and the calculating means to detect or quantify the detection target substance employing both the first component and the second component which are separated and received by the light receiving section. In this case, it is preferable for the calculating means to detect or quantify the second complex by obtaining the degree of polarization of the fluorescence from the first component and the second component. In addition, it is preferable for the separating means to be a polarizing beam splitter.

In the biological molecule detecting apparatus of the present invention, it is preferable for: the light source to emit the excitation light to have a focal point at a specific region within the solution; the light receiving section to receive fluorescence emitted by the fluorescent molecules at the specific region; and the calculating means to detect or quantify the detection target substance based on a parameter that represents the frequency at which the first complex enters and exits the specific region and a parameter that represents the frequency at which the second complex enters and exits the specific region. In this case, it is preferable for the calculating means to be equipped with an autocorrelator, to obtain the parameters as the speed of Brownian motion of the first complex and the second complex by the autocorrelation method, and to detect or quantify the detection target substance by obtaining the average size of molecules which are contained in the solution.

In the biological molecule detecting apparatus of the present invention, it is preferable for: the light receiving section to be equipped with spectral means for spectrally separating light, and a plurality of light receiving means for receiving light which is spectrally separated by the spectral means. In this case, it is preferable for the spectral means to be a plurality of optical filters that transmit light of different wavelengths; and for the light receiving section to further comprise a switching means for switching an optical filter to be employed from among the plurality of optical filters, and switches the optical filter to be employed according to the wavelength of the fluorescence. Alternatively, it is preferable for the spectral means to be a diffraction grating.

It is preferable for the external force imparting means to be equipped with an external force imparting light source that emits light having a wavelength different from that of the excitation light, and to impart external force onto the first complex and the second complex by emitting the light having the wavelength different from that of the excitation light onto the solution. In this case, it is preferable for the external force imparting light source to emit the light having the wavelength different from that of the excitation light onto the solution from a plurality of positions.

In the case that the external force imparting means is the external force imparting light source that emits light having a wavelength different from that of the excitation light, it is preferable for the solution to be held in a solution holding portion having a flat surface at least at a portion thereof. In this case, it is preferable for the orientation means to emit the light having the wavelength different from that of the excitation light in a direction that passes through the solution and exits the flat surface of the solution holding portion such that the light having the wavelength different from that of the excitation light is focused at an interface between the solution and the flat surface.

In the biological molecule detecting apparatus of the present invention, it is preferable for the calculating means to detect or quantify the detection target substance by utilizing the fact that external forces having different intensities are respectively imparted to the first complex and the second complex by the external force imparting means.

A biological molecule detecting method of the present invention is that which detects fluorescence emitted by a first complex and a second complex within a solution, the first complex being formed by a substance that specifically binds with a detection target substance bound to a fluorescent molecule, and the second complex being formed by the first complex bound to the detection target substance, to detect or quantify the detection target substance, comprising:

a step of emitting excitation light toward the fluorescent molecules;

a step of imparting external force onto the first complex and the second complex;

a step of detecting the fluorescence emitted by the fluorescent molecules; and

a step of detecting or quantifying the detection target substance based on the speed of Brownian motion of the first complex and the speed of Brownian motion of the second complex, which are changed by the external force being imparted thereto.

The present invention enables highly sensitive biological molecule detection.

### BRIEF DESCRIPTION OF THE DRAWINGS

FIG. 1A is a first schematic diagram for explaining antigen antibody reactions in a biological molecule detecting apparatus according to a first embodiment.

FIG. 1B is a second schematic diagram for explaining antigen antibody reactions in the biological molecule detecting apparatus according to the first embodiment.

FIG. 2A is a schematic diagram that illustrates a case in which the vibration direction of excitation light and the transition moment of a fluorescent molecule are parallel.

FIG. 2B is a schematic diagram that illustrates a case in which the vibration direction of excitation light and the transition moment of a fluorescent molecule are perpendicular.

FIG. 3A is a schematic diagram that illustrates a free molecule (an antibody and a fluorescent molecule to which an antigen is not bound).

FIG. 3B is a schematic diagram that illustrates a binding molecule (an antibody and a fluorescent molecule to which an antigen is bound).

FIG. 4A is a perspective view that illustrates the outer appearance of the biological molecule detecting apparatus according to the first embodiment.

FIG. 4B is a diagram that illustrates the biological molecule detecting apparatus according to the first embodiment in a state in which an openable portion is opened.

FIG. 5 is a block diagram that illustrates the main components of the biological molecule detecting apparatus.

FIG. 6 is a schematic diagram that illustrates the emission direction of an external force imparting light beam emitted by an external force imparting light source viewed from above.

FIG. 7A is a graph that illustrates the relationship between the speed of Brownian motion and the number of molecules in the case that the external force imparting light beam is not emitted.

FIG. 7B is a graph that illustrates the relationship between the speed of Brownian motion and the number of molecules in the case that the external force imparting light beam is emitted.

FIG. 8 is a schematic diagram that illustrates the detailed structure of a light receiving section of the biological molecule detecting apparatus according to the first embodiment.

FIG. 9 illustrates an example of a calibration curve that represents the relationship between the concentration of a detection target substance and a degree of fluorescent polarization.

FIG. 10 is a diagram that schematically illustrates the flow of a process from preparation of a sample through disposal thereof.

FIG. 11 is a block diagram that illustrates the main components of a biological molecule detecting apparatus according to a second embodiment.

FIG. 12 is a schematic diagram that illustrates the detailed structure of a light receiving section of the biological molecule detecting apparatus according to the second embodiment.

FIG. 13 illustrates an example of a graph that represents the relationship between diffusion time and a correlation function.

FIG. 14 illustrates an example of a calibration curve that represents the relationship between antigen concentration and average diffusion time.

FIG. 15 is a conceptual diagram that illustrates a case in which external force imparting light beams are emitted onto a plurality of points in a reagent cup from the bottom surface thereof.

FIG. 16 is a conceptual diagram that illustrates the structure of an external force imparting light source for causing external force imparting light beams to be emitted onto a plurality of points from a predetermined direction.

FIG. 17 is a conceptual diagram that illustrates an example of the structure of an optical system for casing external force imparting light beams to be emitted onto a plurality of points from a predetermined direction.

FIG. 18 is a conceptual diagram that illustrates another example of the structure of an optical system for casing external force imparting light beams to be emitted onto a plurality of points from a predetermined direction.

FIG. 19 is a conceptual diagram that illustrates a microlens array.

FIG. 20 is a conceptual diagram that illustrates an example of the shape of a reagent cup.

FIG. 21 is a conceptual diagram that illustrates an example of the positional relationship between the focal point of a focused external force imparting light beam and a reagent cup.

### BEST MODE FOR CARRYING OUT THE INVENTION

Hereinafter, embodiments of the present invention will be described with reference to the attached drawings. Various specific reactions are utilized to detect biological molecules. Here, apparatuses that utilize specific reactions between antigens and antibodies, and detect antigens which have reacted with the antibodies, based on fluorescence emitted by fluorescent molecules which are bound to the antibodies as labels, will be described as examples.

### First Embodiment

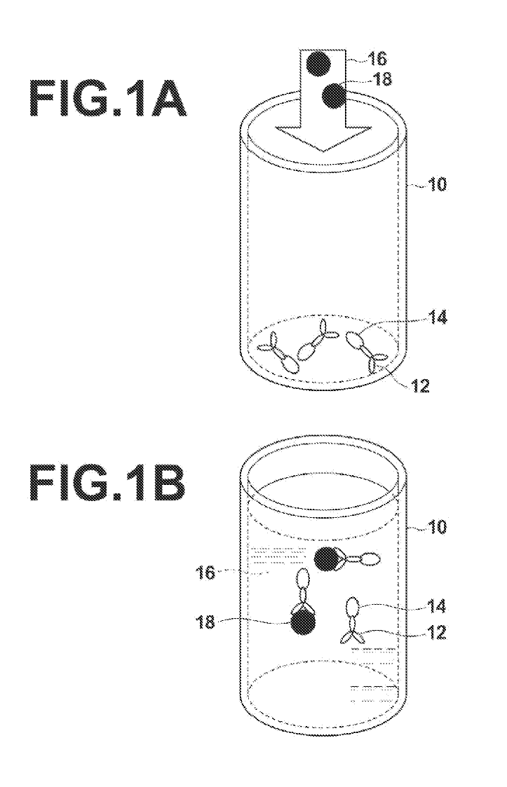

FIG. 1A and FIG. 1B are schematic diagrams that illustrate antigen antibody reactions in a biological molecule detecting apparatus according to a first embodiment. Antigen antibody reactions within a liquid will be described with reference to FIG. 1A and FIG. 1B. Here, a case will be considered in which dry antibodies 12 are placed in a cylindrical reagent cup 10. The antibodies 12 are labeled with fluorescent molecules 14.

In the present embodiment, plasma 16 separated from whole blood is employed as a sample. The plasma 16 is dispensed into the reagent cup 10 and stirred. In the case that antigens 18 that specifically bind with the antibodies 12 are present in the plasma 16, antigen antibody reactions will occur between the antibodies 12 and the antigens 18, and the antibodies 12 and the antigens 18 will be present within the plasma 16 in a specifically bound state, as illustrated in FIG. 1B.

In the present embodiment, a case will be described in which the plasma 16 separated from whole blood is employed as the sample, PSA (Prostate Specific Antigens) are the antigens 18 as the detection target substance, and anti PSA antibodies are employed as the antibodies 12 that specifically bind with the detection target substance. Alexa Fluor 568 (by Molecular Probes) is employed as the fluorescent molecules 14. Alexa Fluor 568 emits fluorescence having wavelengths within a range from 550 nm to 700 nm, with a peak at approximately 610 nm.

A sufficiently great amount of the antibodies 12 is supplied with respect to the antigens 18. Therefore, a portion of the antibodies 12 remain within the plasma 16 without undergoing antigen antibody reactions. Hereinafter, the antibodies 12, the antigens 18, and the fluorescent molecules 14 which are bound to each other by antigen antibody reactions will be referred to as binding molecules, and the antigens 12 and the fluorescent molecules 14 which have not undergone antigen antibody reactions but are present in the liquid will be referred to as free molecules. The binding molecules and the free molecules are both present in the plasma 16. Note that components other than the antigens 18 are present in the plasma 16. However, components other than the antigens 18 are omitted from FIG. 1A and FIG. 1B in order to simplify the description.

The biological molecule detecting apparatus according to the first embodiment of the present invention emits excitation light into the solution, in which the binding molecules and the free molecules are both present, as the solution is a liquid phase. Fluorescence emitted by the fluorescent molecules 14 is received, and detection and quantification of the antigens 18 is performed based on the received fluorescence. Accordingly, it is desirable for only fluorescence emitted from the binding molecules that include the antigens 18 to be detected. However, the free molecules and the binding molecules are both present in the solution. Therefore, when the excitation light is emitted into the solution, the fluorescent molecules 14 associated with the free molecules also emit fluorescence, resulting in unnecessary fluorescent components being generated. Therefore, the biological molecule detecting apparatus according to the first embodiment of the present invention calculates the fluorescence contributed by fluorescent molecules associated with free molecules from among the entirety of fluorescence data.

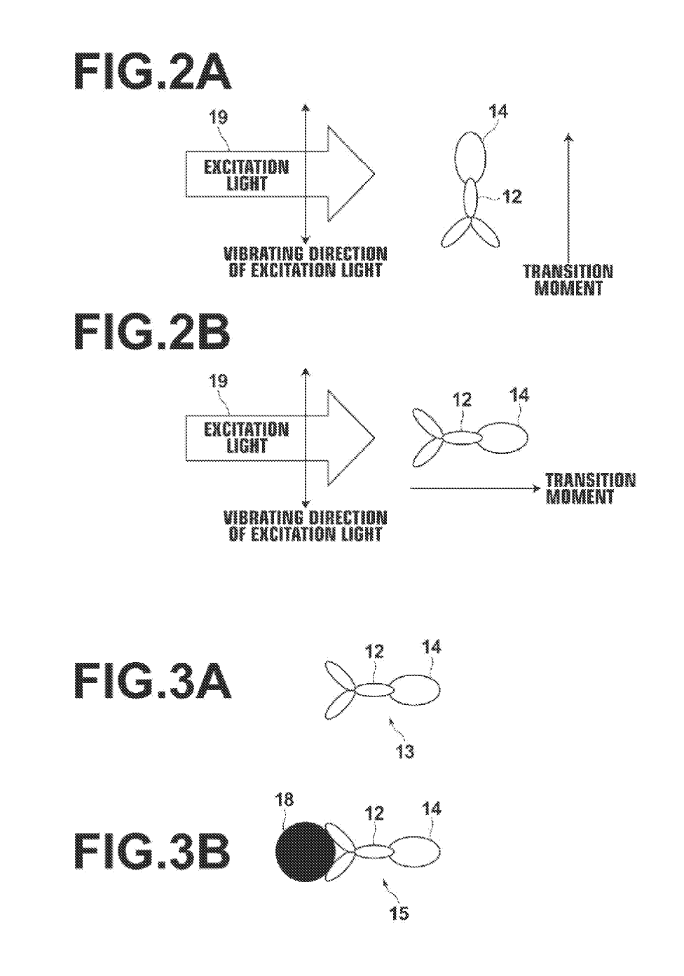

Excitation efficiency of the fluorescent molecules 14 by linearly polarized excitation light will be described with reference to FIGS. 2A and 2B in order to explain the principle of calculating the fluorescence contributed by the binding molecules and the fluorescence contributed by the free molecules in the biological molecule detecting apparatus 100 according to the first embodiment.

FIG. 2A is a schematic diagram that illustrates a case in which the vibration direction of excitation light 19 and the transition moment of a fluorescent molecule 14 are parallel. FIG. 2B is a schematic diagram that illustrates a case in which the vibration direction of excitation light 19 and the transition moment of a fluorescent molecule 14 are perpendicular. Here, cases are described in which the longitudinal direction of the fluorescent molecule 14 is parallel to the orientation direction of the transition moment, to simplify the description. Note that in the present specification, the “vibration direction” of light refers to the vibration direction of an electric field. In the case that light is polarized, the vibration direction is the same as the polarization direction.

The fluorescent molecules 14 transition to an excited state when light energy is absorbed, and emits fluorescence during the process of returning to a baseline state. When the fluorescent molecules 14 are excited, vectors within the fluorescent molecules called transition moments, which are determined by the molecular structures of the fluorescent molecules 14, interact with the excitation light 19. The transition moments have unique directions within the fluorescent molecules 14, and the relationship between the directions of the transition moments and the vibration direction of the excitation light 19 determines the excitation efficiency of the fluorescent molecules 14. Specifically, the fluorescent molecules 14 selectively absorb light that vibrates in a direction parallel to the transition moments thereof. Accordingly, in the case that the excitation light 19 is emitted onto a fluorescent molecule 14 while vibrating in the vertical direction of the drawing sheet and propagating from the left to the right of the drawing sheet as illustrated in FIGS. 2A and 2B, the excitation efficiency becomes greatest in the case that the vibration direction of the excitation light 19 is parallel to the transition moment of the fluorescent molecule 14 (FIG. 2A), and becomes 0 in the case that the vibration direction of the excitation light 19 is perpendicular to the transition moment of the fluorescent molecule 14 (FIG. 2B). The orientations of the transition moments change according to the orientations of the fluorescent molecules 14, and therefore the orientations of the fluorescent molecules 14 within the solution influence the excitation efficiencies thereof.

Motion of the free molecules 13 and the binding molecules 15 within the solution will be described with reference to FIGS. 3A and 3B in order to consider the orientations of the fluorescent molecules 14 within the solution. FIG. 3A is a schematic diagram that illustrates an antibody 12 and a fluorescent molecule 14, the combination of which is a free molecule 13. FIG. 3B is a schematic diagram that illustrates an antibody 12, an antigen 18, and a fluorescent molecule 14, the combination of which is a binding molecule.

The free molecules 13 and the binding molecules 15 move irregularly (Brownian motion) within the solution, and undergo movement within the solution and rotational movement. It is known that Brownian motion of molecules within solutions is influenced by absolute temperature, the volumes of the molecules, the viscosity of the solutions, etc. The volumes of the binding molecules 15 are greater than those of the free molecules 13 due to the antigens 18 being bound thereto, and are less likely to undergo Brownian motion within the solution.

A technique (fluorescence polarization immunoassay) that detects changes in Brownian motion caused by the sizes of molecules changing based on changes in the degree of polarization of fluorescence to detect a detection target substance is known. The degree of polarization is a measure that represents the polarized state of light, and assumes a value from 0 to 1. In the case that light is completely polarized (linearly polarized, for example), the degree of polarization is 1, and the degree of polarization of non polarized light is 0.

Generally, when a fluorescent molecule 14 is excited by linearly polarized excitation light, the fluorescent molecule 14 emits fluorescence which is polarized in the same direction as the polarization direction of the excitation light. The degree of polarization of fluorescence emitted by the fluorescent molecules 14 depends on the speed of Brownian movement thereof. That is, if a fluorescent molecule 14 is not undergoing Brownian movement, the fluorescent molecule 14 emits fluorescence which is polarized in the same direction as the vibration direction of the excitation light. The degree of polarization of the fluorescence emitted by fluorescent molecules 14 decreases as the speed at which they are undergoing Brownian movement becomes greater.

Speeds of rotational movement of the free molecules 13 and the binding molecules 15 within the solution differ due to the masses and volumes thereof. For this reason, the degrees of polarization of fluorescence emitted by the fluorescent molecules 14 associated with the free molecules 13 and fluorescence emitted by the fluorescent molecules 14 associated with the binding molecules 15 differ from each other, and the degree of polarization of fluorescence emitted by the fluorescent molecules 14 associated with the binding molecules 15 is greater.

The degree of fluorescence polarization P is defined by Formula (I) below, and represents the degree of rotation that the fluorescent molecules undergo from excitation to fluorescence emission. I1 represents fluorescence which is polarized in a direction parallel to the vibration direction of linearly polarized excitation light, and I2 represents fluorescence which is polarized in a direction perpendicular to the vibration direction of linearly polarized excitation light.

P=(I1−I2)/(I1+I2) (1)

The relationship among the free molecules 13, the binding molecules 15, and the degree of polarization in the present embodiment is that in which the greater the number of binding molecules 15 having greater volume and mass corresponding to the antigens 18 than the free molecules 13, that is, the greater the number of fluorescent molecules that emit fluorescent which is polarized in a direction parallel to the vibration direction of linearly polarized excitation light, the greater the degree of polarization of fluorescence.

However, the fluorescence polarization immunoassay technique detects changes in the degrees of polarization of fluorescence caused by changes in Brownian motion, which is random movement, and therefore there is a limit to the detection sensitivity. Particularly in the case that the volume and the mass of a detection target substance (antigens in this case) are small, significant differences between the speed of Brownian movement of the free molecules 13 and the speed of Brownian movement of the binding molecules 15 are not expressed, and there are cases in which the degree of polarization of fluorescence does not change greatly.

Therefore, the biological molecule detecting apparatus according to the first embodiment of the present invention utilizes laser beams to impart external force onto the free molecules 13 and the binding molecules 15 within the solution, to cause significant differences to be generated between the speed of Brownian movement of the free molecules 13 and the speed of Brownian movement of the binding molecules 15, to measure the degrees of polarization of fluorescence with high precision.

When a laser beam is emitted onto the free molecules 13 and the binding molecules 15 within the solution, external force is imparted onto the free molecules 13 and the binding molecules 15, and Brownian motion thereof is inhibited. If the external force imparted onto the binding molecules 15 by the laser beam is designated as Fb and the external force imparted onto the free molecules by the laser beam is designated as Ff, the intensity of the external force which is imparted onto the free molecules 13 and the binding molecules 15 differ because the volumes and the masses differ according to the presence or absence of the antigens 18, and Fb>Ff.

The biological molecule detecting apparatus according to the first embodiment of the present invention generates a significant difference between the degrees of polarization of fluorescence emitted by the free molecules 13 and the binding molecules 15, by applying external forces of different intensities thereto, to inhibit the Brownian motion thereof.

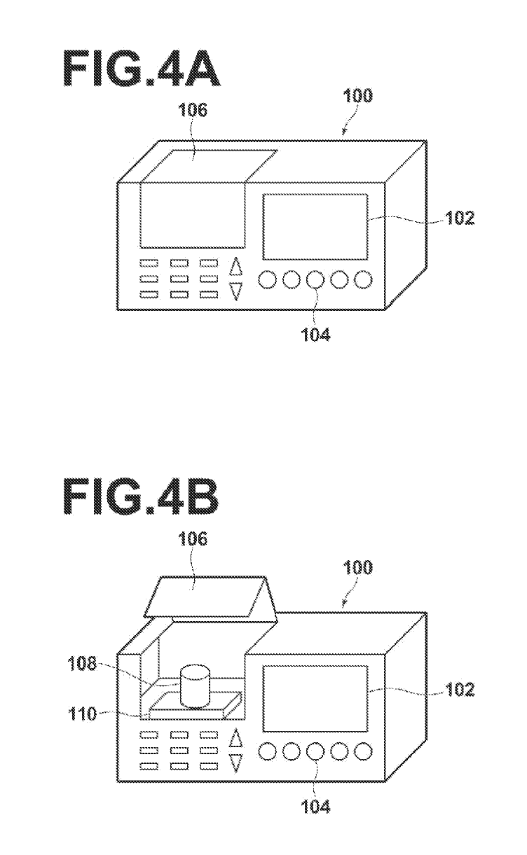

The configuration of the biological molecule detecting apparatus 100 according to the first embodiment of the present invention will be described. FIG. 4A is a perspective view that illustrates the outer appearance of the biological molecule detecting apparatus 100. A display section 102, a user input section 104, and an openable portion 106 are provided on a side surface of the biological molecule detecting apparatus 100. The display section 102 displays measurement results and the like. The user input section 104 is a section at which modes are set, sample data are input, etc. The openable portion 106 is of a configuration in which an upper lid may be opened. The upper lid is opened when samples are set, and closed during measurements. By adopting this configuration, light from the exterior influencing measurements can be prevented.

FIG. 4B is a perspective view that illustrates the biological molecule detecting apparatus 100 in a state in which the openable portion 106 is opened. When the openable portion 106 is opened, a reagent cup 108 and a holding base 110 are present within the biological molecule detecting apparatus 100. The reagent cup 108 is removably held by the holding base 110. The reagent cup 108 is a cylindrical container in which solutions are placed. Users dispense samples into the reagent cup 108 and close the upper lid to perform measurements. Although not illustrated in the drawings, the biological molecule detecting apparatus 100 is also equipped with a reagent tank and a dispensing section. When measurements are initiated, the dispensing section suctions a reagent from within the reagent tank, and dispenses the reagent into the reagent cup 108.

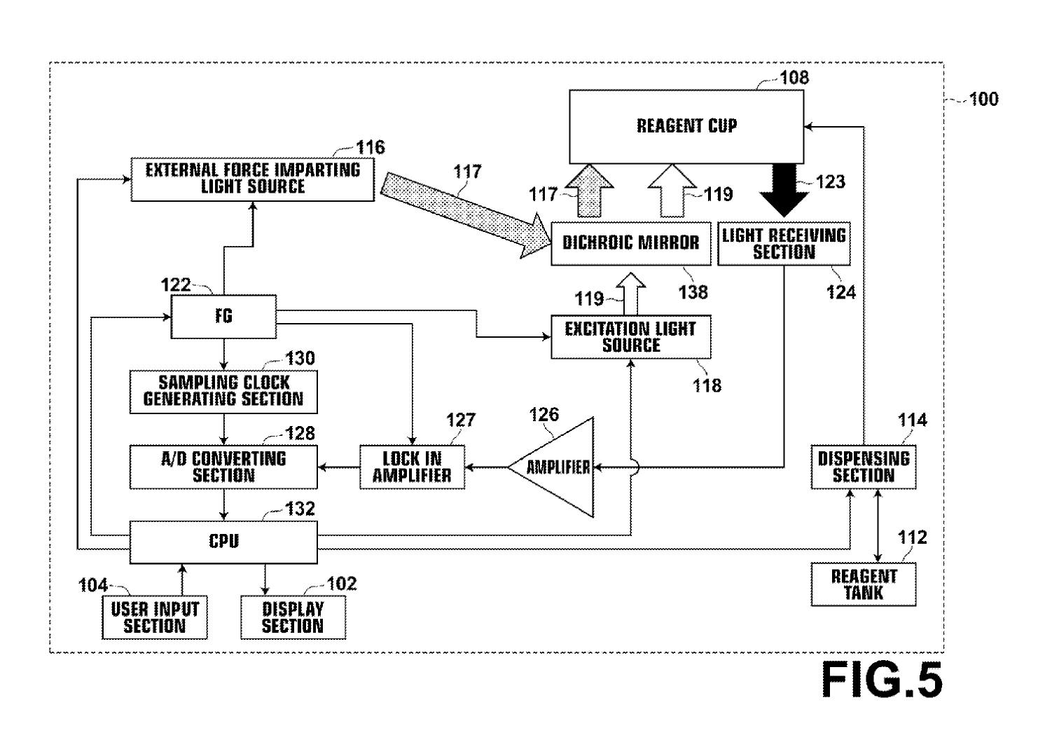

FIG. 5 is a functional block diagram that illustrates the main components of the biological molecule detecting apparatus 100. The biological molecule detecting apparatus 100 includes: the display section 102; the user input section 104; the reagent cup 108; the reagent tank 112; the dispensing section 114; an external force imparting light source 116; an excitation light source 118; an FG (Function Generator) 122; a light receiving section 124; an amplifier 126; a lock in amplifier 127; an A/D converting section 128; a sampling clock generating section 130; a CPU 132; and a dichroic mirror 138.

The reagent cup 108 is a container in which reagents stored in the reagent tank 112 and samples collected from patients or the like are caused to react. The reagent cup 108 is removably attached to the biological molecule detecting apparatus 100. The capacity of the reagent cup 108 is approximately 120 μL.

The reagent tank 112 is a tank in which a plurality of types of reagents are stored. The free molecules 13 are stored in the reagent tank 112 as reagents.

The dispensing section 114 is constituted by a removably pipette, a suctioning device, etc. The dispensing section 114 suctions reagents to be utilized for measurement from the reagent tank 112 and dispenses the suctioned reagents to the reagent cup 108, according to commands from the CPU 132.

The external force imparting light source 116 emits an external force imparting light beam 117 toward the dichroic mirror 138, to impart external force onto the free molecules 13 and the binding molecules 15 which are present in a solution within the reagent cup 108. The external force imparting light source 116 is turned ON and OFF periodically based on voltage signals output from the FG 122. A laser beam having a wavelength of 980 nm and an output of 100 mW, for example, is employed as the external force imparting light beam 117. The external force imparting light beam 117 has a width capable of illuminating the entirety of the solution within the reagent cup 108.

The excitation light source 118 emits excitation light 119, which is linearly polarized by a polarizing element provided within the excitation light source 118, that excites the fluorescent molecules 14, toward the reagent cup 108 via the dichroic mirror 138. Light having a wavelength of 532 nm and an output of 1 mW, for example, is employed as the excitation light.

The dichroic mirror 138 reflects light having a specific wavelength, and transmits light having other wavelengths. The dichroic mirror 138 reflects the external force imparting light beam 117 and transmits the excitation light 119.

The FG 122 is a device capable of generating voltage signals having various frequencies and waveforms. The FG 122 outputs different voltage signals to the external force imparting light source 116, the excitation light source 118, the lock in amplifier 127, and a sampling clock generating section 130 in response to commands received from a CPU 132.

The light receiving section 124 is constituted by filters, photodiodes, etc. The light receiving section 124 is provided beneath the reagent cup 108. The light receiving section 124 receives fluorescence 123 generated by the fluorescent molecules 14 within the reagent cup 108 under the reagent cup 108, converts the received fluorescence signals to analog electrical signals (analog fluorescence data), and outputs the analog electrical signals to the amplifier 126.

The amplifier 126 amplifies the analog fluorescence data output thereto from the light receiving section 124, and outputs the amplified analog fluorescence data to the lock in amplifier 127.

The lock in amplifier 127 converts the analog fluorescence data to direct current frequencies. Square waves are input to the lock in amplifier 127 from the FG 122 as a reference signal. The square waves have the same period as the voltage signals output from the FG 122 to the external force imparting light source 116. The lock in amplifier 127 detects frequency components equal to the reference signal from among the analog fluorescence data output from the amplifier 126. Specifically, the lock in amplifier 127 converts only frequency components equal to the reference signal to direct current signals by synchronous detection, and transmits only the direct current signals through a low pass filter provided therein. The lock in amplifier 127 outputs the direct current signals to the A/D converting section 128. The lock in amplifier 127 detects components having the same period as the period during which the external force imparting light source 116 emits light from among the analog fluorescence data output by the amplifier 126. The influence of stray light and electric noise included in the analog fluorescence data is reduced, by detecting the components having the same period as the period during which the external force imparting light source 116 emits light.

The sampling clock generating section 130 inputs a sampling clock that specifies the timings at which the A/D converting section 128 is to sample the analog fluorescence data to the A/D converting section 128, based on voltage signals output thereto from the FG 122.

The A/D converting section 128 samples the analog fluorescence data output thereto from the lock in amplifier 127, based on the sampling clock output thereto from the sampling clock generating section 130. The A/D converting section 128 converts the sampled analog fluorescence data to digital data, and outputs the digital data to the CPU 132.

The CPU 132 performs calculations using the digital data output thereto from the A/D converting section 128, and outputs the results of calculations to the display section 102. In addition, the CPU 132 controls the operations of the external force imparting light source 116, the excitation light source 118, the dispensing section 114, and the FG 122 in response to commands input from the user input section 104. Specifically, the CPU 132 outputs ON/OFF commands to the external force imparting light source 116 and the excitation light source 118, outputs commands that specify a reagent to be utilized and commands to initiate dispensing operations to the dispensing section 114, and outputs commands that specify the waveform of voltage signals to be output and commands to output the voltage signals to the FG 122.

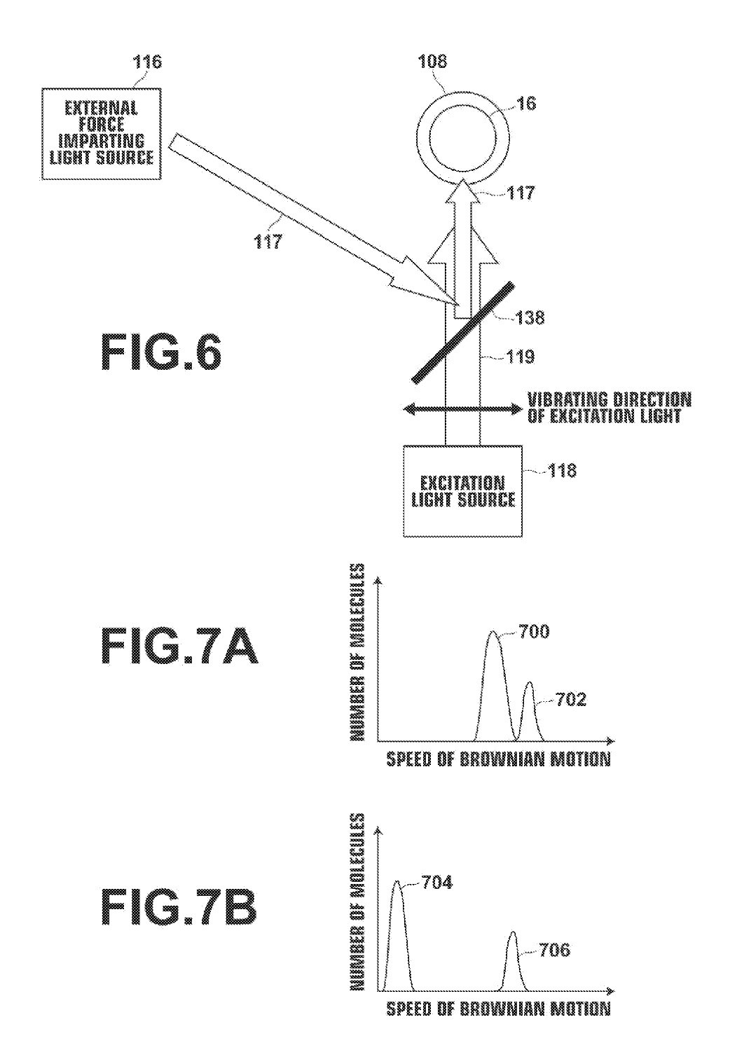

FIG. 6 is a schematic diagram that illustrates the interior of the biological molecule detecting apparatus 100 from above, to explain the emission direction of an external force imparting light beam emitted by an external force imparting light source 116.

The external force imparting light beam 117 emitted by the external force imparting light source 116 is reflected by the dichroic mirror 138 and is irradiated onto the side surface of the reagent cup 108.

The dichroic mirror 138 only reflects light having the wavelength of the external force imparting light beam 117, and transmits light having other wavelengths.

The excitation light 119 emitted from the excitation light source 118 passes through the dichroic mirror 138, propagates in the same direction as the external force imparting light beam 117 reflected by the dichroic mirror 138, and enters the side surface of the reagent cup 108.

The external force imparting light beam 117 that enters the reagent cup 108 imparts external force onto the free molecules 13 and the binding molecules 15 within the reagent cup 108, and inhibits the Brownian motion of these molecules.

FIG. 7A is a graph that illustrates the relationship between the speed of Brownian motion and the number of molecules in the case that the external force imparting light beam is not emitted. FIG. 7B is a graph that illustrates the relationship between the speed of Brownian motion and the number of molecules in the case that the external force imparting light beam is emitted. Note that the graphs are schematically drawn in FIG. 7A and FIG. 7B, in order to facilitate understanding.

Curve 700 is a graph that represents the relationship between the speed of Brownian motion of binding molecules and the number of molecules. Curve 702 is a graph that represents the relationship between the speed of Brownian motion of free molecules and the number of molecules. The Brownian motion of the binding molecules is slower than the Brownian motion of the free molecules. In addition, the number of binding molecules is greater than the number of free molecules in this example.

The Brownian motion of the free molecules 13 and the binding molecules 15 within the reagent cup 108, which is irradiated by the external force imparting light beam 117, is inhibited by the external force. The external force imparting light beam 117 imparts greater force to molecules having larger volumes. Therefore, the external force received by the binding molecules 15 is greater than the external force received by the free molecules 13. Accordingly, the Brownian motion of the binding molecules 15 is inhibited by a greater force than the force that inhibits the Brownian motion of the free molecules 13, and the Brownian motion of the binding molecules 15 becomes slower than usual (indicated by curve 704 of FIG. 7B).

The fluorescence emitted by the binding molecules 15 irradiated by the external force imparting light beam 117 has a high degree of polarization because the speed of Brownian motion of the binding molecules 15 is slower than that when the external force imparting light beam 117 is not emitted, and includes a large number of components which are polarized in the direction parallel to the vibration direction of the excitation light 119.

Meanwhile, the external force received by the free molecules 13 is less than the external force received by the binding molecules, because the volume of the free molecules 13 is less than the volume of the binding molecules. For this reason, the speed of Brownian motion of the free molecules 13 does not change greatly regardless of the presence or absence of the external force imparting light beam 117 (indicated by curve 706 of FIG. 7B). Accordingly, there is little change in the degree of polarization of fluorescence emitted by the fluorescent molecules 14 associated with the free molecules 13 due to the presence or absence of the external force imparting light beam 117.

That is, a significant difference between the speeds of Brownian motion of the free molecules 13 and the binding molecules 15 when the external force imparting light beam 117 is emitted onto the free molecules 13 and the binding molecules 15 compared to a case in which the external force imparting light beam 117 is not emitted. The difference between the speeds of Brownian motion results in a great difference in the degrees of polarization of fluorescence emitted by the fluorescent molecules associated with the free molecules and the fluorescent molecules associated with binding molecules. Therefore, the biological molecule detecting apparatus 100 is capable of highly precise measurements of the degrees of fluorescent polarization.

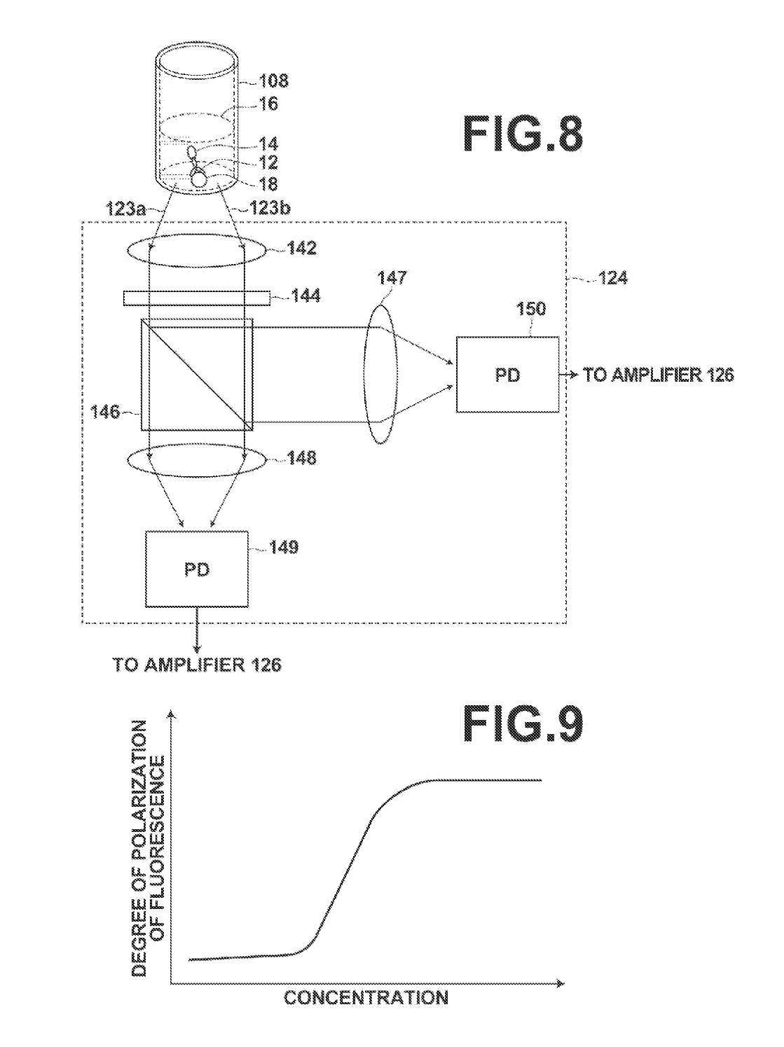

Next, the detailed structure of the light receiving section 124 will be described with reference to FIG. 8. FIG. 8 is a schematic diagram that illustrates the detailed structure of the light receiving section 124. The light receiving section 124 includes: a lens 142; a filter 144; a polarizing beam splitter 146; a lens 147; a lens 148; and PD's (photodiodes) 149 and 150.

The light receiving section 124 receives fluorescence from the bottom side of the reagent cup 108. Fluorescence 123a emitted by the fluorescent molecules 14 within the reagent cup 108 and enters the light receiving section 124 toward the left side of the drawing sheet and fluorescence 123b emitted by the fluorescent molecules 14 and enters the light receiving section 124 toward the right side of the drawing sheet are focused and collimated by the lens 142, then enter the polarizing beam splitter 146 after passing through the filter 144. Note that although not illustrated in FIG. 8, fluorescence is present between the fluorescence 123a and the fluorescence 123b. However, the behavior of such fluorescence is predictable by those skilled in the art, and therefore a description thereof will be omitted.

The filter 144 is a band pass filter that cuts off light other than the fluorescence emitted by the fluorescent molecules 14, and prevents light other than the fluorescence, such as the excitation light, from entering the PD 149 and the PD 150.

The polarizing beam splitter 146 only transmits light which vibrates in the same direction as the vibration direction of the excitation light 119, and reflects light that vibrates in the direction perpendicular to the vibration direction of the excitation light 119.

The fluorescence that passes through the polarizing beam splitter 146 is focused by the lens 148, and enters the PD 149. The fluorescence reflected by the polarizing beam splitter 146 is focused by the lens 147 and enters the PD 150.

The PD 149 is constituted by an APD (Avalanche Photodiode). The PD 149 generates current corresponding to the intensity of the fluorescence focused by the lens 148 and outputs the current to the amplifier 126.

The PD 150 is constituted by an APD. The PD 150 generates current corresponding to the intensity of the fluorescence focused by the lens 147 and outputs the current to the amplifier 126.

In this manner, the light receiving section 124 separates the fluorescence emitted by the fluorescent molecules 14 into a component having a vibration direction parallel to the vibration direction of the excitation light 119, a second component having a vibration direction perpendicular to the vibration direction of the excitation light 119, and causes currents based on the amounts of each component to be generated. In addition, the light receiving section 124 receives the fluorescence from the bottom side of the reagent cup 108. Therefore, the light receiving section 124 is not likely to be influenced by the external force imparting light beam 117 and the excitation light 119.

The CPU 132 obtains the degrees of polarization of fluorescence by performing the calculation of Formula (I) on the current components based on the fluorescence separated by the light receiving section 124. When the external force imparting light beam 117 is emitted, a significant difference is generated between the speed of Brownian motion of the free molecules 13 and the speed of Brownian motion of the binding molecules 15. Therefore, the ratio of the number of each type of molecule will be expressed by the degrees of polarization of fluorescence.

The CPU 132 has a different calibration curve function for each item of measurement stored in advance, and converts the degrees of polarization of fluorescence into concentrations of antigens. FIG. 9 illustrates an example of a calibration curve function. The calibration curve functions are measured from samples in which the concentrations of specific substances are known. The CPU 132 outputs the calculated concentration of the antigen to the display section 102.

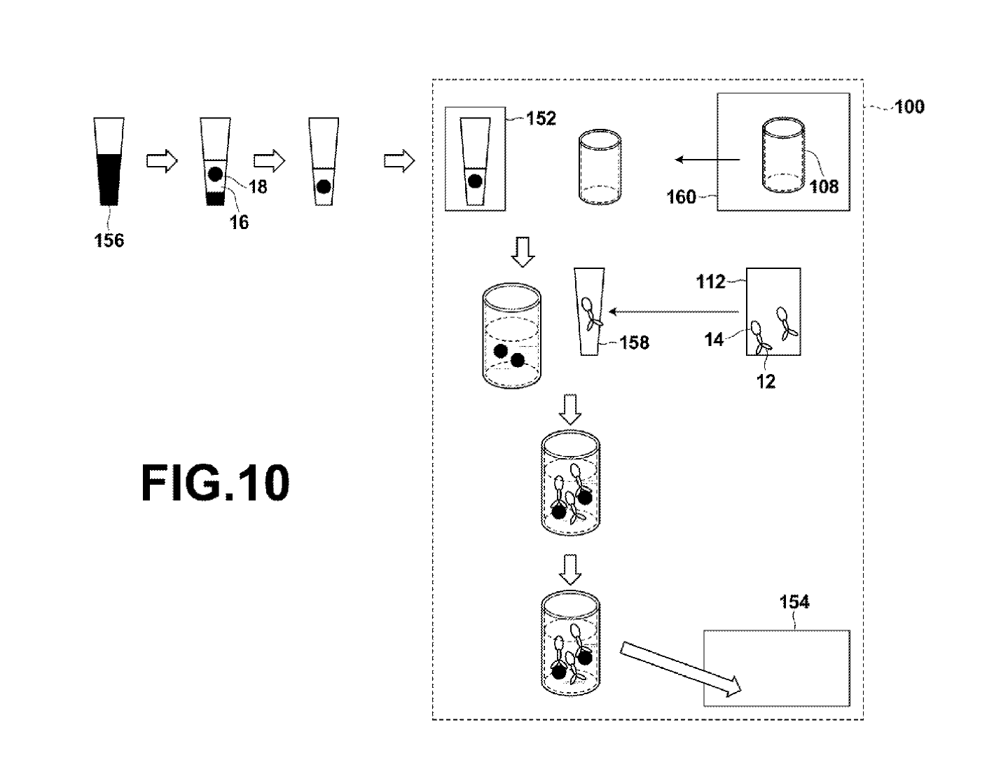

Next, the operations of the biological molecule detecting apparatus 100 during measurements will be described. FIG. 10 is a diagram that schematically illustrates the flow of a process from preparation of a sample through disposal thereof.

To prepare for measurement, first, 50 μL of whole blood 156 collected from a patient is centrifugally separated to separate plasma 16. The separated plasma 16 is set in a sample setting section 152 of the biological molecule detecting apparatus 100. The steps up to this point are performed by a user.

The biological molecule detecting apparatus 100 dispenses the plasma 16, which is set in the sample setting section 152, into a new reagent cup 108, which is stocked in a reagent cup stocking section 160. Next, the biological molecule detecting apparatus 100 suctions anti PSA antibodies, which are in the reagent tank 112, with a pipette 158, and dispenses the suctioned anti PSA antibodies into the reagent cup 108. The biological molecule detecting apparatus 100 which has placed the plasma and the anti PSA antibodies into the reagent cup 108 uses a built in vortex mixer to agitate the reagent cup 108 while maintaining the temperature of the reagent cup 108 at 37° C. to cause antigen antibody reactions to occur. Thereafter, the biological molecule detecting apparatus 100 emits excitation light, detects fluorescence, and disposes of the reagent cup 108 into a built in trash receptacle 154 after the fluorescence is detected.

As described above, the biological molecule detecting apparatus 100 of the first embodiment of the present invention is configured to emit the external force imparting light beam 117 to impart external force onto the free molecules and the binding molecules within the solution, to inhibit Brownian motion of the molecules. In this configuration, the influence of the external force imparted by the external force imparting light beam 117 on the binding molecules having large volumes is great, while the influence of the external force on the free molecules is small. That is, the biological molecule detecting apparatus 100 imparts external force of different intensities to the free molecules and the binding molecules by emitting the external force imparting light beam 117, to cause a significant difference to be generated between the speed of Brownian motion of the free molecules and the speed of Brownian motion of the binding molecules. As a result, the change in the ratio of the number of the free molecules and the number of the binding molecules clearly appears as a change in the degrees of polarization of fluorescence. Therefore, the concentration of the detection target substance can be more accurately calculated by calculating the change in the degrees of polarization of fluorescence. Note that in the present embodiment, the CPU is a calculating means that detects or quantifies the detection target substance.

In addition, in the configuration described above, the biological molecule detecting apparatus 100 imparts external force of different intensities to the free molecules and the binding molecules by emitting the external force imparting light beam 117. Therefore, measurements can be performed at a higher sensitivity compared to a case in which the degrees of polarization of fluorescence are measured using random Brownian motion.

Note that the present embodiment was described as a case in which antigen antibody reactions are utilized as an example. However, the combination of the detection target substance and the substance that specifically binds with the detection target substance is not limited to the case described above. For example, the present invention may be applied to cases in which antigens are employed to detect antibodies, cases in which a specific nucleic acid is employed to detect a nucleic acid that hybridizes with the specific nucleic acid, cases in which nucleic acids are employed to detect nucleic acid binding proteins, cases in which ligands are employed to detect receptors, cases in which sugars are employed to detect lectin, cases in which protease detection is utilized, cases in which higher order structure changes are utilized, etc.

In addition, the first embodiment employed a laser having a wavelength of 980 nm and an output of 100 mW as the external force imparting light beam 117. However, the external force imparting light beam 117 is not limited to a laser having this wavelength and output. It is desirable for the wavelength and the output of the external force imparting light beam 117 to be determined based on the ease with which the free molecules and the binding molecules rotate within the solution, which is influenced by the volumes of the free molecules and the binding molecules, the masses of the free molecules and the binding molecules, the viscosity of a solvent, absolute temperature, etc. Particularly, it is desirable for a laser having an output to a degree that results in a significant difference between the speed of Brownian motion of the free molecules and the speed of Brownian motion of the binding molecules.

In addition, the present embodiment employed light having a wavelength of 532 nm and an output of 1 mW as the excitation light 119. However, the light to be employed as the excitation light 119 is not limited to light having this wavelength and output. The wavelength of the excitation light is selected as appropriate, based on the wavelength band which is absorbed by the fluorescent molecules.

### Second Embodiment

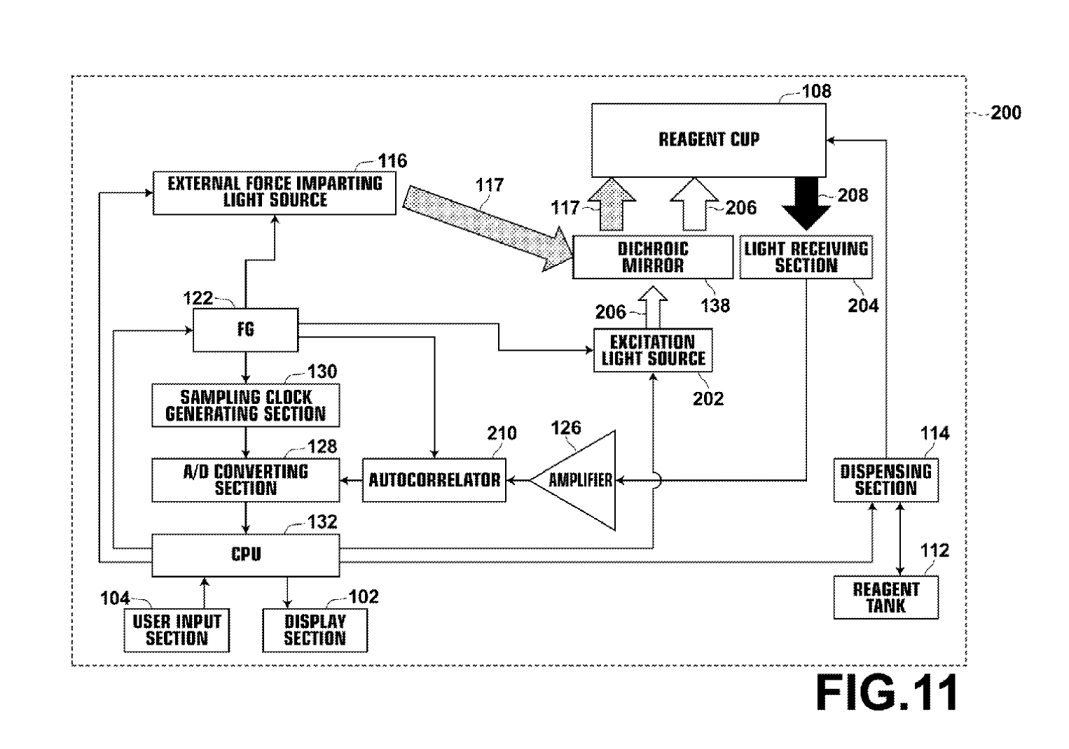

FIG. 11 is a block diagram that illustrates the main components of the biological molecule detecting apparatus 200 according to the second embodiment. Note that constituent elements of the biological molecule detecting apparatus 200 which are the same as those of the biological molecule detecting apparatus 100 of the first embodiment are denoted with the same reference numerals, and detailed descriptions thereof will be omitted.

The biological molecule detecting apparatus 200 is different from the biological molecule detecting apparatus 100 of the first embodiment in the configurations of an excitation light source 202, a light receiving section 204, and an autocorrelator 210. The biological molecule detecting apparatus 200 detects binding molecules using the principle of the FCS (fluorescence correlation spectroscopy) method.

The excitation light source 202 is constituted by a laser light source and an objective lens having a high magnification ratio. Excitation light 206 emitted by the excitation light source 202 is focused on a region of approximately 1 femtoliter within the solution in the reagent cup 108.

The light receiving section 204 detects fluorescence emitted by the fluorescent molecules within the reagent cup 108.

The free molecules and the binding molecules within the solution are undergoing Brownian motion. Therefore, they randomly enter and exit the region in which the excitation light 206 is focused. The free molecules and the binding molecules that enter the region are excited by the excitation light 206. The free molecules are of a smaller volume and mass than the binding molecules. Therefore the speed of Brownian motion thereof is fast, and they pass through the region quickly. Accordingly, the change in fluorescent intensity is also fast. The binding molecules are of a greater volume and mass than the free molecules. Therefore the speed of Brownian motion thereof is slow, and they pass through the region slowly. Accordingly, the change in fluorescent intensity is also slow.

The biological molecule detecting apparatus 200 emits the external force imparting light beam 117 onto the free molecules and the binding molecules. Therefore, a significant difference is generated between the speed of Brownian motion of the free molecules and the speed of Brownian motion of the binding molecules. Accordingly, the binding molecules pass through the region at an even slower speed than when the external force imparting light beam 117 is not being emitted. In contrast, because the speed of Brownian motion of the free molecules does not change greatly compared to a case when the external force imparting light beam 117 is emitted, they pass through the region quickly.

The autocorrelator 210 obtains the speeds of movement of molecules from the speed of fluctuations in fluorescent intensity by the autocorrelation method, and estimates the average size of the molecules. Because the binding molecules have volumes which are greater than those of the free molecules due to the antigens being bound thereto, the average size becomes greater as the number of binding molecules is greater.

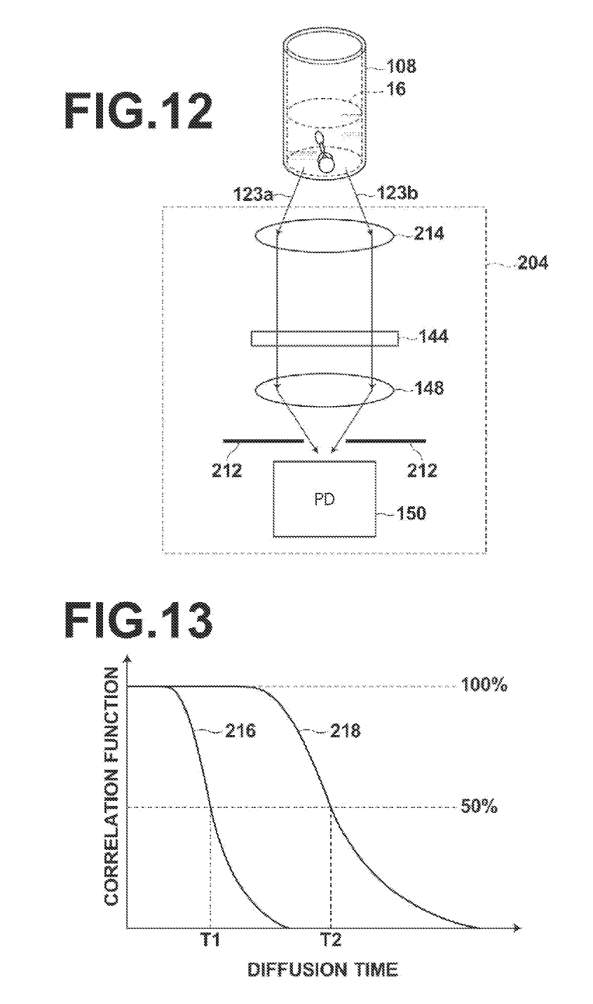

FIG. 12 is a schematic diagram that illustrates the detailed configuration of the light receiving section 204 of the biological molecule detecting apparatus 200 according to the second embodiment. The light receiving section 204 is equipped with: a lens 214; a filter 144; a lens 148; a pinhole 212; and a PD 150. Fluorescence 123a emitted by the fluorescent molecules 14 within the reagent cup 108 and enters the light receiving section 124 toward the left side of the drawing sheet and fluorescence 123b emitted by the fluorescent molecules 14 and enters the light receiving section 124 toward the right side of the drawing sheet are focused and collimated by the lens 214, pass through the filter 144, are focused by the lens 148; pass through the pinhole 212, then enter the PD 150. Note that although not illustrated in FIG. 12, fluorescence is present between the fluorescence 123a and the fluorescence 123b. However, the behavior of such fluorescence is predictable by those skilled in the art, and therefore a description thereof will be omitted.

The lens 214 is an objective lens having a high magnification ratio that focuses and collimates the fluorescence which is emitted in the small region at which the excitation light has its focal point within the reagent cup 108.

The pinhole 212 removes light which returns from locations other than the surface of the focal point of the excitation light 206, and transmits only the fluorescence which is emitted from the surface of the focal point.

FIG. 13 is a graph that represents the relationship between diffusion time output by the autocorrelator 210 and a correlation function. Curve 216 is an example that represents the relationship between diffusion time and the correlation function for a light molecule, and curve 218 is an example that represents the relationship between diffusion time and the correlation function for a heavy molecule. The diffusion time is longer for heavier molecules, as the speed of Brownian motion thereof is slow.

If the maximum value of the correlation function is designated as 100%, the diffusion time for a value of 50% for the correlation function is defined as the average diffusion time. In FIG. 13, the average diffusion time for the curve 216 is T1, and the average diffusion time for the curve 218 is T2. The average diffusion time will become longer as the percentage of heavy molecules included in the solution is greater. The CPU 132 calculates the percentage of binding molecules within the solution, by calculating an average diffusion speed from a formula that represents the relationship between the diffusion time output by the autocorrelator 210 with the correlation function.

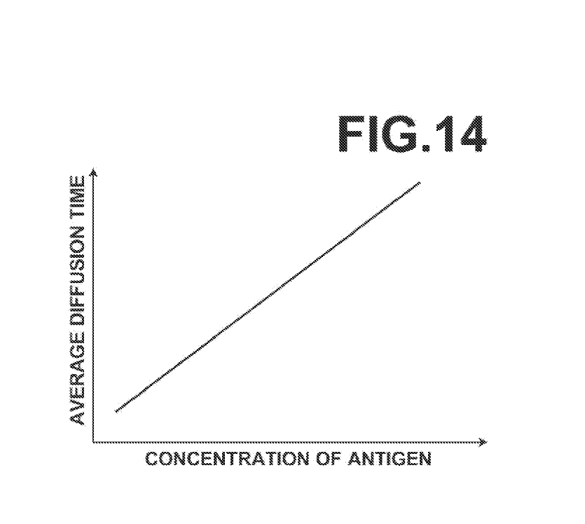

FIG. 14 illustrates an example of a calibration curve that represents the relationship between antigen concentration and average diffusion time. The CPU 132 employs a calibration curve such as that illustrated in FIG. 14, to convert the calculated average diffusion speed to an antigen concentration. The CPU 132 causes the display section 102 to display the obtained antigen concentration.

As described above, the biological molecule detecting apparatus 200 of the second embodiment of the present invention is configured to emit the external force imparting light beam 117 to impart external force onto the free molecules and the binding molecules within the solution, to inhibit Brownian motion of the molecules. In this configuration, the influence of the external force imparted by the external force imparting light beam 117 on the binding molecules having large volumes is great, while the influence of the external force on the free molecules is small. That is, the biological molecule detecting apparatus 200 imparts external force of different intensities to the free molecules and the binding molecules by emitting the external force imparting light beam 117, to cause a significant difference to be generated between the speed of Brownian motion of the free molecules and the speed of Brownian motion of the binding molecules. As a result, a significant difference is generated in the speeds at which the free molecules and the binding molecules pass through the small region at which the excitation light has its focal point, and the autocorrelator can more accurately obtain the percentage of the binding molecules. Therefore, the concentration of the detection target substance can be more accurately calculated. Note that in the present embodiment, the autocorrelator 210 and the CPU 132 are the calculating means that detects or quantifies the detection target substance.

Note that the second embodiment was described as a case in which antigen antibody reactions are utilized as an example. However, the combination of the detection target substance and the substance that specifically binds with the detection target substance is not limited to the case described above. For example, the present invention may be applied to cases in which antigens are employed to detect antibodies, cases in which a specific nucleic acid is employed to detect a nucleic acid that hybridizes with the specific nucleic acid, cases in which nucleic acids are employed to detect nucleic acid binding proteins, cases in which ligands are employed to detect receptors, cases in which sugars are employed to detect lectin, cases in which protease detection is utilized, cases in which higher order structure changes are utilized, etc.

### (Design Modifications to the First and the Second Embodiments)

Note that the embodiments of the present invention described above are merely examples of the present invention, and do not limit the structure of the present invention. The biological molecule detecting apparatus of the present invention is not limited to the embodiments described above, and various changes and modifications are possible as long as they do not stray from the objective of the present invention.

For example, the external force applied to the molecules within the solution is not limited to that applied by a laser beam as the external force imparting light beam. Magnetic methods or electric methods may be employed as long as they apply external force of different intensities to the free molecules and binding molecules to become complete.

Complex mechanisms are obviated in the case that the external force imparting light beam is employed to impart external forces on molecules compared to a case that external force is imparted to molecules by magnets, etc. In order to impart external forces on molecules using magnets, for example, the molecules need to be magnetic, or magnetic molecules that bind with molecules of which the orientations are to be controlled need to be prepared, and preparations for measurements become complex.

Note that the Alexa Fluor 568 was employed as the fluorescent molecules in the embodiments of the present invention. However, the fluorescent molecules are not limited to this product.

Cases in which a single reagent cup is provided within the biological molecule detecting apparatus were described in the above embodiments. However, it is not necessary for a single reagent cup to be employed, and a configuration may be adopted in which a plurality of reagent cups, in which a plurality of samples are set, are provided in the biological molecule detecting apparatus. In this case, if the apparatus is configured to sequentially move the reagent cups to measurement positions and to perform measurements, a plurality of samples can be automatically measured.

Note that the above embodiments were described as cases in which antibodies labeled with fluorescent molecules were employed. However, it is not necessary to use antibodies which have already been labeled with fluorescent molecules. For example, binding of antibodies and antigens and binding of the antibodies and fluorescent molecules may be simultaneously performed within a reagent cup. In this case, a user may prepare antibodies and fluorescent molecules in separate reagent tanks, and the biological molecule detecting apparatus may dispense the antibodies, the fluorescent molecules, and a sample into a reagent cup, to cause reactions to occur when performing measurements.

In addition, the external force imparting light source 116 and the excitation light source 118 may be configured to be removable, such that they may be replaced by those appropriate to a detection target substance and the type of fluorescent molecule.

Note that in the embodiments of the present invention described above, cases were described in which whole blood was employed as samples. However, the sample is not limited to being whole blood, and other bodily fluids such as urine and spinal fluid may be employed as samples as long as detection target substances are dispersed within solutions thereof.

Note that in the embodiments of the present invention, cases in which one type of substance was the detection target substance were described as examples. However, the detection target substance is not necessarily limited to one type of substance. In the case that there are two types of detection target substances, for example, two types of molecules that specifically adsorb to the two types of detection target substances, and these molecules are labeled with fluorescent molecules that have different emission wavelengths. If two types of filters are provided at the light receiving section, the filter to be utilized is switched according to the emission wavelength of the fluorescent molecules that label the molecules to be measured, and the fluorescence emitted from the molecules are received separately, the fluorescence emitted by each type of fluorescent molecule can be quantified. Alternatively, fluorescent molecules having different excitation wavelengths or different fluorescent lifetimes may be employed.

The embodiments of the present invention employed filters as spectral separating means that spectrally separate light at the light receiving section. However, it is not necessary for filters to be used. For example, light can be spectrally separated using a diffraction grating or a prism such that only light having specific wavelengths are received by the photodiode.

In addition, there may be more than two types of detection target substances. In such a case as well, each detection target substance can be detected separately, by employing substances that specifically bind with each detection target substance, labeling these substances with different fluorescent molecules, and by detecting the fluorescence emitted by each type of fluorescent molecule separately through filters corresponding to each type of fluorescence.

Note that as the number of types of detection target substances increase, the number of types of fluorescent molecules also increases, and fluorescence having different wavelengths emitted from the plurality of types of fluorescent molecules will all be present. There are cases in which it is difficult to separate the fluorescence using only filters. In these cases, separation of fluorescence may be facilitated by increasing the number of types of excitation light. The degree of light absorption of fluorescent molecules depends on the wavelength of excitation light, and each type of fluorescent molecule has a wavelength band that can be absorbed more readily. For this reason, only a portion of the fluorescent molecules will emit fluorescence by changing the wavelength of the excitation light, and separation of fluorescence using filters is facilitated. In addition, detection of fluorescence emitted by target fluorescent molecules will be facilitated by employing band pass filters having narrower transmission bandwidths.

The embodiments of the present invention can perform measurements in a liquid phase, in which antigens, antibodies, and fluorescent molecules are dispersed within a solution, and therefore exhibits the advantage that preliminary processes are simple compared to solid phase measurements. Further, the antigens and the free molecules are not fixed to a solid phase, and therefore the antigens and free molecules can move freely within the solution, resulting in faster reactions than those during measurements using the solid phase.

The biological molecule detecting apparatus and the biological molecule detecting method of the present invention may be employed by RICS (Raster Imaging Correlation Spectroscopy), FRAP (Fluorescence Recovery After Photobleaching) analysis, FIDA (Fluorescence Intensity Distribution Analysis), FIDA-PO Fluorescence Intensity Distribution Analysis Polarization System), etc.

In addition, the number of external force imparting light sources is not limited to one for each emission direction in the present invention. A plurality of external force imparting light sources that emit a plurality of laser beams in a single direction may be provided.

There is a problem that the range of a solution that can be irradiated by the external force imparting light beam will become smaller in the case that the external force imparting light beam is focused in order to impart greater external force. It is preferable for the external force imparting light beam to be simultaneously emitted onto a plurality of points from a certain direction.

Providing a plurality of optical systems is an example of a method for increasing an irradiation range by simultaneously emitting the external force imparting light beam onto a plurality of points from a certain direction. The plurality of optical systems may have a plurality of optical paths at least at a stage prior to the laser beam entering the reagent cup. For example, if three optical systems that also include light sources are provided, external force imparting light beams are emitted from all three external force imparting light sources, and the external force imparting light beams can irradiate three points of the reagent cup from a certain direction. As another example, a single external force imparting light beam may be branched by employing a two dimensional laser array, a microlens array, etc, and the external force imparting light beams can be emitted onto a plurality of points corresponding to the number of branches, even if only a single light source is provided.

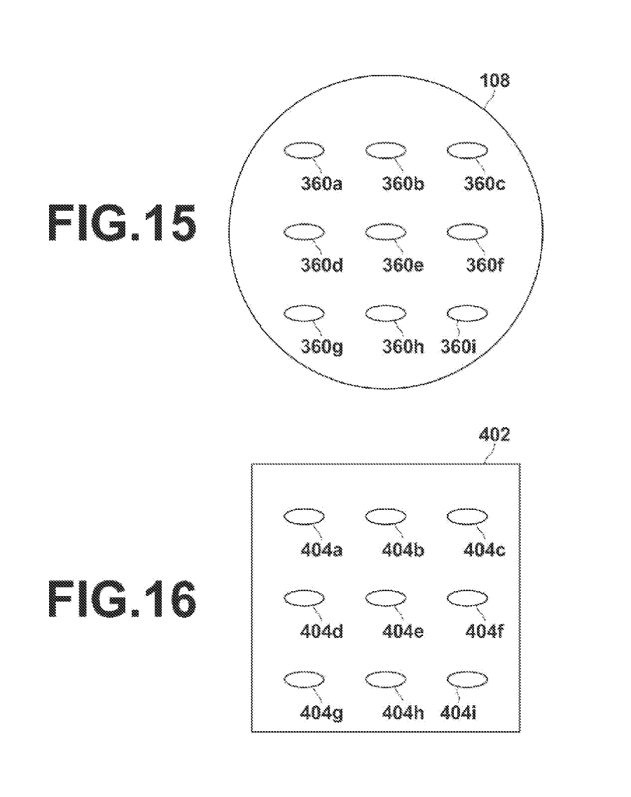

The method that utilizes a branched external force imparting light beam may be that illustrated in FIG. 15 (a plan view of the reagent cup 108), in which nine laser beams corresponding to nine points 360a through 360i enter the reagent cup 108. By adopting such a configuration, the range of the solution that can be irradiated by the external force imparting light beam becomes grater, thereby avoiding the aforementioned problem. Note that although an example in which external force imparting light beams enter nine points is described here, the number of points that the external force imparting light beams enter is not limited to nine, and may be greater or less than nine. It is desirable for external force imparting light beams to enter a greater number of points the narrower that they are focused. Thereby, sudden variations in fluorescent intensity can be reduced, and the coefficient of variation, which is an index that represents relative spreading, can be improved.

The structure of an external force imparting light source 402 that causes external force imparting light beams to simultaneous enter a plurality of points from a predetermined direction is illustrated in FIG. 16. The external force imparting light source 402 is a 3·3 two dimensional laser array. Nine light emitting points 404a through 404i of the external force imparting light source 402 emit light. The light emitting points have heights of 1 μm and widths of 100 μm. The distances among the light emitting points are approximately 100 μm.

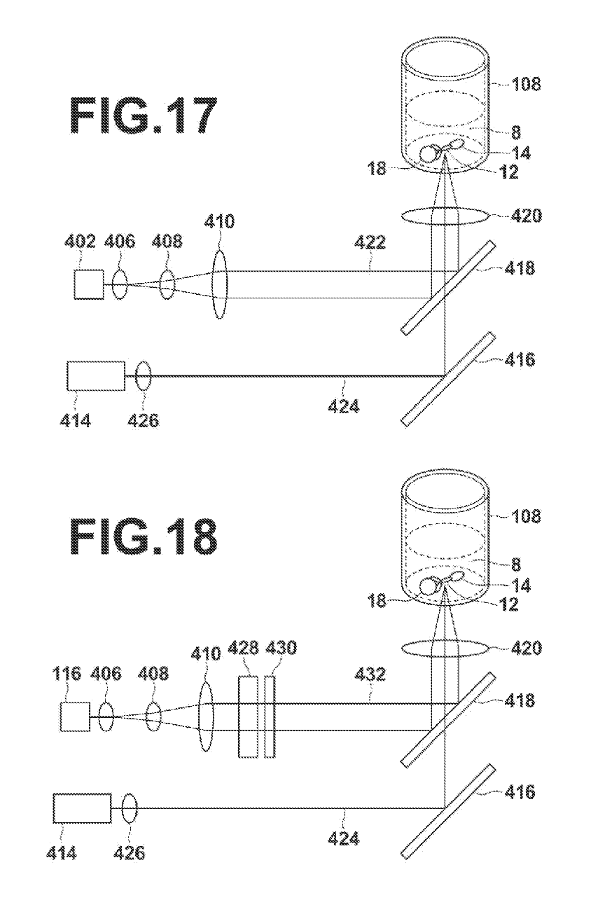

An example of an optical system that employs the external force imparting light source 402 of FIG. 16 is illustrated in FIG. 17. Note that structural elements other than the optical systems for laser beams and excitation light are omitted in FIG. 17.

External force imparting light beams 422 output from the external force imparting light source 402 pass through a collimating lens 406 and become collimated light beams at a focal point. The external force imparting light beams 422 which have passed through the collimating lens 406 pass through beam expanders 408 and 410. The external force imparting light beams 422 which have passed through the beam expanders 408 and 410 are spread to become a collimated light beam having a specific magnification ratio. Thereafter, the external force imparting light beams 422 are reflected by a dichroic mirror 418, focused by a lens 420, enter the reagent cup 108 through the bottom surface thereof, and propagate upward.

Excitation light 424 output from a light source 414 passes through a lens 426 and is reflected by a dichroic mirror 416. The excitation light 424 which has been reflected by the dichroic mirror 416 passes through a dichroic mirror 418, is focused by a lens 420, enters the reagent cup 108 through the bottom surface thereof, and propagates upward.

If the focal distance of the collimating lens 406 is set to be 3.1 mm, and the focal distance of the lens 420 is set to be 4 mm in the optical system illustrated in FIG. 17, the magnification ratio will be 1.29×. Therefore, the sizes of the external force imparting light beams 422 are approximately 1.3 μm·130 μm with pitches of approximately 129 μm at the bottom surface of the reagent cup 108.

Another example of an optical system that causes laser beams to simultaneously enter a plurality of points from a predetermined direction will be described with reference to FIG. 18. Note that structural elements other than the optical systems for laser beams and excitation light are omitted in FIG. 18. In addition, structural elements which are the same as those illustrated in FIG. 17 are denoted by the same reference numerals, and detailed descriptions thereof will be omitted.

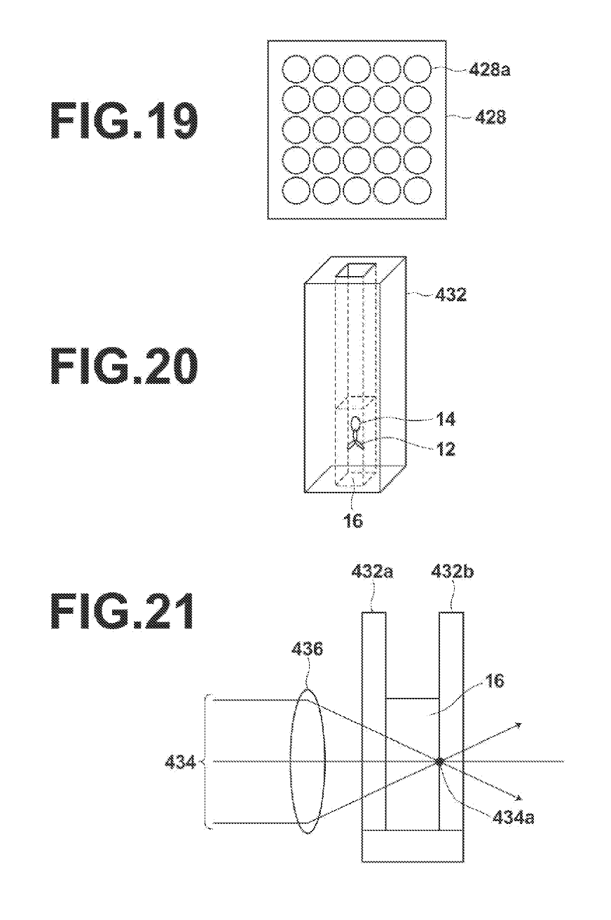

In the optical system illustrated in FIG. 18, the external force imparting light source 116 is the same as that of the first embodiment. An external force imparting light beam 432 passes through the collimating lens 406, the beam expanders 408 and 410, and enters a microlens array 428. As illustrated in FIG. 19, the microlens array 428 has a plurality of microlenses 428a arrayed in a lattice shape. The external force imparting light beam 432 which passes through the microlens array 428 becomes a plurality of light beams which have different focal points, in the same manner as light emitted by a plurality of light sources. The external force imparting light beam 432 is focused by a pinhole array 430, reflected by the dichroic mirror 418, focused by the lens 420, enters the reagent cup 108 through the bottom surface thereof, and propagates upward. External force imparting light beams can be caused to simultaneously enter a plurality of points from a predetermined direction by employing a microlens array in this manner as well.

In addition, the reagent cup was of a cylindrical shape in the embodiments described above. However, it is not necessary for the shape of the reagent cup to be cylindrical. For example, a reagent cup 432 shaped as a rectangular column and having a rectangular columnar solution portion therein may be employed, as illustrated in FIG. 20. The reagent cup 432 having the rectangular columnar solution portion is particularly suited in cases that pressure applied by the external force imparting light beam in the propagation direction thereof is utilized to press the free molecules and the binding molecules against the surface of an inner wall of the reagent cup 432. This is a phenomenon that occurs in cases that the masses of the free molecules and the binding molecules are light, caused by the free molecules and the binding molecules moving through the solution under the pressure applied by the external force imparting light beam. In this case, if the solution holding portion is a rectangular column, Brownian motion of the free molecules and the binding molecules is inhibited while the free molecules and the binding molecules are being pressed against the interface between the solution and the reagent cup 432. In the case that the interface is a flat surface and the pressure applied by the external force imparting light beam operates in a direction perpendicular to the interface, the free molecules and the binding molecules will not move outside the irradiation range of the external force imparting light beam by moving in directions parallel to the interface.

In addition, in the case that the free molecules and the binding molecules are pressed against the surface of the inner wall of the reagent cup 432, Brownian motion of the molecules can be more easily inhibited by setting the position of the focal point of the external force imparting light beam. FIG. 21 is a diagram that illustrates the positional relationship between the focal point of a focused external force imparting light beam and a reagent cup. A external force imparting light beam 434 enters a lens 436 and is focused at a focal point 434a at the interface between the plasma 16 and a side wall 432b (the inner surface of the side wall 432b). The intensity of the external force imparting light beam 434 is greatest at the position of the focal point 434a, and therefore the free molecules and the binding molecules can be pressed with a great amount of pressure. Accordingly, if the laser 434 is emitted in the manner illustrated in FIG. 21, Brownian motion of the free molecules and the binding molecules can be more efficiently inhibited while pressing the free molecules and the binding molecules against the inner surface of the side wall 432b.

Note that it is not necessary for the solution holding portion to be shaped as a rectangular column, and the solution holding portion needs only to have at least one flat surface. If a external force imparting light beam is emitted such that it is focused at a focal point on the flat surface, the free molecules and the binding molecules will not move outside the irradiation range of the external force imparting light beam by moving in directions parallel to the flat surface, and Brownian motion thereof will be inhibited while they are being pressed against the flat surface.

### FIELD OF INDUSTRIAL APPLICABILITY

The biological molecule detecting apparatus and the biological molecule detecting method of the present invention may be utilized in apparatuses that detect or quantify detection target substances by utilizing interactions between the detection target substances and substances that specifically bind to the detection target substances.

What is claimed is:

1. A biological molecule detecting apparatus that detects fluorescence emitted by a first complex and a second complex within a solution, the first complex being formed by a substance that specifically binds with a detection target substance bound to a fluorescent molecule, and the second complex being formed by the first complex bound to the detection target substance, to detect or quantify the detection target substance, comprising:
a light source that emits excitation light toward the fluorescent molecules;
a light receiving section that detects the fluorescence emitted by the fluorescent molecules;
external force imparting means for imparting external force onto the first complex and the second complex; and
a calculating means that detects or quantifies the detection target substance based on the speed of Brownian motion of the first complex and the speed of Brownian motion of the second complex, which are changed by the external force being imparted thereto.

2. A biological molecule detecting apparatus as defined in claim 1, wherein:
the light source emits linearly polarized excitation light that excites the fluorescent molecules;
the light receiving section has separating means for separating the fluorescence emitted by the fluorescent molecules into a first component having a vibration direction parallel to the vibration direction of the excitation light, and a second component having a vibration direction perpendicular to the vibration direction of the excitation light; and
the calculating means detects or quantifies the detection target substance employing both the first component and the second component which are separated and received by the light receiving section.

3. A biological molecule detecting apparatus as defined in claim 2, wherein:
the calculating means detects or quantifies the second complex by obtaining the degree of polarization of the fluorescence from the first component and the second component.

4. A biological molecule detecting apparatus as defined in claim 2, wherein:
the separating means is a polarizing beam splitter.

5. A biological molecule detecting apparatus as defined in claim 1, wherein:
the light source emits the excitation light to have a focal point at a specific region within the solution;
the light receiving section receives fluorescence emitted by the fluorescent molecules at the specific region; and
the calculating means detects or quantifies the detection target substance based on a parameter that represents the frequency at which the first complex enters and exits the specific region and a parameter that represents the frequency at which the second complex enters and exits the specific region.

6. A biological molecule detecting apparatus as defined in claim 5, wherein:
the calculating means is equipped with an autocorrelator, obtains the parameters as the speed of Brownian motion of the first complex and the second complex by the autocorrelation method, and detects or quantifies the detection target substance by obtaining the average size of molecules which are contained in the solution.

7. A biological molecule detecting apparatus as defined in claim 1, wherein:
the light receiving section is equipped with spectral means for spectrally separating light, and a plurality of light receiving means for receiving light which is spectrally separated by the spectral means.

8. A biological molecule detecting apparatus as defined in claim 5, wherein:
the light receiving section is equipped with spectral means for spectrally separating light, and a plurality of light receiving means for receiving light which is spectrally separated by the spectral means.

9. A biological molecule detecting apparatus as defined in claim 7, wherein:
the spectral means is a plurality of optical filters that transmit light of different wavelengths; and
the light receiving section further comprising a switching means for switching an optical filter to be employed from among the plurality of optical filters, and switching the optical filter to be employed according to the wavelength of the fluorescence.

10. A biological molecule detecting apparatus as defined in claim 8, wherein:
the spectral means is a plurality of optical filters that transmit light of different wavelengths; and
the light receiving section further comprising a switching means for switching an optical filter to be employed from among the plurality of optical filters, and switching the optical filter to be employed according to the wavelength of the fluorescence.

11. A biological molecule detecting apparatus as defined in claim 7, wherein:
the spectral means is a diffraction grating.

12. A biological molecule detecting apparatus as defined in claim 1, wherein:
the external force imparting means is equipped with an external force imparting light source that emits light having a wavelength different from that of the excitation light, and imparts external force onto the first complex and the second complex by emitting the light having the wavelength different from that of the excitation light onto the solution.

13. A biological molecule detecting apparatus as defined in claim 2, wherein:
the external force imparting means is equipped with an external force imparting light source that emits light having a wavelength different from that of the excitation light, and imparts external force onto the first complex and the second complex by emitting the light having the wavelength different from that of the excitation light onto the solution.

14. A biological molecule detecting apparatus as defined in claim 5, wherein:
the external force imparting means is equipped with an external force imparting light source that emits light having a wavelength different from that of the excitation light, and imparts external force onto the first complex and the second complex by emitting the light having the wavelength different from that of the excitation light onto the solution.

15. A biological molecule detecting apparatus as defined in claim 12, wherein:
the external force imparting light source emits the light having the wavelength different from that of the excitation light onto the solution from a plurality of positions.

16. A biological molecule detecting apparatus as defined in claim 12, wherein:
the solution is held in a solution holding portion having a flat surface at least at a portion thereof.

17. A biological molecule detecting apparatus as defined in claim 16, wherein:
the external force imparting means emits the light having the wavelength different from that of the excitation light in a direction that passes through the solution and exits the flat surface of the solution holding portion such that the light having the wavelength different from that of the excitation light is focused at an interface between the solution and the flat surface.

18. A biological molecule detecting apparatus as defined in claim 1, wherein:
the calculating means detects or quantifies the detection target substance by utilizing the fact that external forces having different intensities are respectively imparted to the first complex and the second complex by the external force imparting means.

19. A biological molecule detecting method that detects fluorescence emitted by a first complex and a second complex within a solution, the first complex being formed by a substance that specifically binds with a detection target substance bound to a fluorescent molecule, and the second complex being formed by the first complex bound to the detection target substance, to detect or quantify the detection target substance, comprising:
a step of emitting excitation light toward the fluorescent molecules;
a step of imparting external force onto the first complex and the second complex;
a step of detecting the fluorescence emitted by the fluorescent molecules; and
a step of detecting or quantifying the detection target substance based on the speed of Brownian motion of the first complex and the speed of Brownian motion of the second complex, which are changed by the external force being imparted thereto.
